(19) United States
(12) Patent Application Publication
(10) Pub. No.: US 2021/0054866 A1
(43) Pub. Date: Feb. 25, 2021

(54) BIMETALLIC SCREW WITH MARTENSITICALLY HARDENABLE STEEL

(71) Applicant: HILTI AKTIENGESELLSCHAFT, Schaan (LI)

(72) Inventors: Frederic POL, Feldkirch (AT); Roland SCHNEIDER, Schlins (AT); Michael BISCHOF, Bregenz (AT)

(21) Appl. No.: 16/963,568

(22) PCT Filed: Feb. 28, 2019
(86) PCT No.: PCT/EP2019/054951

§ 371 Date: Jul. 21, 2020

(30) Foreign Application Priority Data
Mar. 8, 2018 (EP) 18160618.7

(51) Int. Cl. F16B 33/00; C22C 38/44; C22C 38/04; C23C 8/32; C21D 9/00; C21D 6/00

(52) U.S. Cl. CPC F16B 33/00; C22C 38/44; C22C 38/04; C21D 6/004; C21D 9/0093; C21D 6/005; C23C 8/32

(57) ABSTRACT

A method for producing a bimetallic screw with a tip element and a drive element, in which a first blank comprising a steel with 0.07 to 0.14% by weight carbon, 13 to 15% by weight chromium, 1.3 to 1.7% by weight molybdenum, 1.5 to 2.0% by weight nickel and 1.0 to 1.5% by weight manganese is provided and the tip element is made from the first blank. A bimetallic screw with a tip element and a drive element is also provided, the tip element and the drive element having a different material composition, and the tip element comprising at least in some areas a steel with 0.07 to 0.14% by weight carbon, 13 to 15% by weight chromium, 1.3 to 1.7% by weight molybdenum, 1.5 to 2.0% by weight nickel and 1.0 to 1.5% by weight manganese.

The invention relates to a method for producing a bimetallic screw with a tip element and a drive element according to the preamble of claim 1, and also to a bimetallic screw with a tip element and a drive element, the tip element and the drive element having a different material composition, according to the preamble of claim 8.

For concrete screws and self-tapping screws for steel-metal applications, material concepts with high surface hardness, at least in some areas of the screw, high core toughness, high resistance to general corrosion, pitting corrosion as well as chloride- or hydrogen-induced embrittlement and good plastic formability are often desired. According to EP2204244 A1 and the concrete screws that are offered under the name “Hilti HUS-HR”, this is achieved by means of hard-metal cutting elements that are welded onto the screw thread in the tip area of the screw, the screw otherwise being made of stainless austenitic A4 steel, comparable to 1.4401.

In the area of stainless self-tapping screws for steel-metal applications, so-called bimetallic screws are known, distinguished by the fact that a stud-shaped tip element made of hardenable carbon steel is welded on the drive element, i.e. the head and the rear part of the shaft, made of austenitic stainless A2 or A4 steel (comparable to 1.4301 or 1.4401). After welding and forming, this stud is hardened by means of a local heat treatment.

DE4033706 A1 describes a heat treatment process for increasing the corrosion resistance of a hardened surface layer of near-net shape components made of stainless martensitic steels with less than 0.4% by weight carbon by diffusing 0.2 to 0.8% by weight nitrogen into the surface layer. An application in screws is not taught by DE4033706 A1 however and, in particular, DE4033706 A1 does not deal with matching the chemical composition of the steel and the heat treatment parameters for an application in screws.

DE19626833A1 describes a method for producing a highly corrosion-resistant martensitic surface layer over a ferritic-martensitic core in components made of stainless steel. The chemical composition of the steel is limited in such a way that there is a ferritic-martensitic structure and, after case hardening at a temperature of 1050° C.-1150° C. with nitrogen, the ferrite content in the core is between 40 and 90% by volume and the core hardness is less than 300 HV30. Once again, an application of the method for screws is not taught.

DE102013108018 A1 describes a screw made of a stainless steel, for example 1.4113, the steel being essentially free of nickel, a surface layer having an increased content of dissolved nitrogen compared to the rest of the structure as a result of a nitriding heat treatment at 1000-1200° C., and the screw having a martensitic structure in the surface layer and otherwise a ferritic structure.

WO14040995 A1 describes a method for producing a self-tapping concrete screw in which a blank made of a martensitically hardenable steel, in particular with a carbon content of less than 0.07%, is hardened at a temperature greater than 900° C. in a nitrogenous gas atmosphere.

TW201418549 A describes a bimetallic screw of which the tip element contains a martensitic steel comprising 0.26 to 0.40% carbon, 12 to 14% chromium, 0 to 0.6% nickel and 0 to 1% manganese.

The European patent application with the application number 17177789.9 describes the use of a steel with 0.07 to 0.14% by weight carbon, 13 to 15% by weight chromium, 1.3 to 1.7% by weight molybdenum, 1.5 to 2.0% by weight nickel and 1.0 to 1.5% by weight manganese, for producing a screw form, the screw form being able to form part of a finished screw at the end of the process.

The abstract available through the link:

https://online.unileoben.ac.at/mu_online/wbAbs.showThesis?pThesisNr=61746&pOrgNr=1 indicates that martensitic steels case-nitrided by the high-temperature gas nitriding process and with 14% chromium can be particularly suitable for use as a material for a fastening element.

The object of the invention is to provide a method for producing a bimetallic screw with which a particularly efficient, easy-to-assemble and corrosion-resistant bimetallic screw can be obtained with particularly low production outlay. It is also an object of the invention to provide a bimetallic screw with the aforementioned advantages.

The object is achieved according to the invention by a method according to claim 1 and a screw according to claim 8. Preferred embodiments are specified in the dependent claims.

A method according to the invention is used to produce a bimetallic screw, that is to say a screw in which the front tip element and the rear drive element have a different material composition. To make the tip element, a first blank comprising a steel with a proportion by weight of 0.07 to 0.14% by weight carbon, 13 to 15% by weight chromium, 1.3 to 1.7% by weight molybdenum, 1.5 to 2.0% by weight nickel and 1.0 to 1.5% by weight manganese is used. The first blank preferably consists of this steel. In addition, the steel of the first blank may comprise other elements customary in steel, for example vanadium (in particular <0.2% by weight), niobium (in particular <0.2% by weight), titanium (in particular <0.2% by weight) and/or silicon (in particular <0.5% by weight). The rest is iron with inevitable impurities, for example sulfur and/or phosphorus, in particular in each case <0.02% by weight. The figures given as “% by weight” can be understood as meaning percentages by weight in a customary sense. In particular, the steel of the first blank can be referred to as a martensitically hardenable, stainless steel. The steel preferably has a proportion by weight of 0.08 to 0.12% by weight carbon.

A first basic idea of the invention can be seen in the fact that stainless martensitic steels can be promising candidates for meeting the sometimes conflicting requirements demanded of the steel used in the tip area of a screw, in particular a self-tapping screw. In order to meet the diverse requirements with regard to high surface hardness and sufficient hardening depth, good corrosion resistance, good toughness and high resistance to chloride- or hydrogen-induced embrittlement, the chemical composition of the steel (in particular with regard to the alloying constituents carbon, chromium, molybdenum, nickel and manganese) and the multi-stage heat treatment required for setting the property profile, consisting of high-temperature gas nitriding, gas-phase quenching, low-temperature cooling, tempering and optional local induction hardening, are carefully matched.

The invention includes the use of a steel of a chemical composition based on a combination of the alloying constituents carbon (0.07-0.14% by weight, preferably 0.08-0.12% by weight), chromium (13-15% by weight), molybdenum (1.3-1.7% by weight), nickel (1.5-2.0% by weight) and manganese (1.0-1.5% by weight, preferably 1.2% by weight) in the first blank, i.e. for making the tip element of the bimetallic screw.

Within the scope of the invention, it has been recognized that, with such a steel, in particular in connection with a heat treatment that is matched to the steel, preferably in several stages, a property profile that is particularly advantageous for the tip area of bimetallic screws, in particular concrete screws, can be obtained, in particular with regard to that the tip area of a self-tapping screw is often responsible for the majority of the cutting work in the substrate and for introducing the load deep into the substrate.

As explained in detail below, this advantageous property profile can be based in particular on an austenitization with a structure stabilization by delta ferrite content during the heat treatment. In particular, it has been possible to create a property profile distinguished by good formability, a high surface hardness of 580 HV0.3 or higher, a maximum core hardness of 450 HV0.3 or lower, a high resistance to general corrosion and pitting corrosion in the core (represented by a PRE index of 17 or higher) and in the surface zone (represented by a PRE index of 23 or higher), a high toughness in the core (in particular as a result of a combination of a low carbon content and stable delta ferrite, which causes the coarse grain growth in the heat treatment to be suppressed) and a high resistance to chloride- or hydrogen-induced embrittlement. In detail, the steel used in the first blank can be advantageous in particular in the following respects:

1) As a result of the carbon content of the steel, the core hardness is a maximum of 450 HV0.3 or less.
2) The following results from the contents of carbon, chromium, molybdenum, nickel and manganese:
a) A relatively high PRE index (pitting resistance equivalent), preferably of 17 or higher, can be achieved without however leaving the range of states of a martensitic or martensitic-ferritic structure.
b) The steel is easy to process into semi-finished forms such as wire rod or drawn bare wire. Both wire rod and bare wire have good cold formability, preferably represented by a yield strength Rₚ 0.2 of <650 N/mm², which can be advantageous in particular for cold forming processes, preferably rolling processes, for thread forming.
c) With case hardening in the temperature range between 1000° C. and 1150° C., preferably between 1030° C. and 1100° C., a predominantly austenitic structure (preferably between 70%-95%) with a small proportion of delta ferrite of 5%-30% can form in the core area of the first blank, it being possible for this delta ferrite content of 5%-30% to have a stabilizing effect on the structure at the said temperatures and thus counteract grain coarsening, which can have an advantageous effect on the toughness properties. The delta ferrite content can be deliberately limited to a maximum of 30%, since with higher delta ferrite contents the toughness could decrease again. The austenitic structure proportion of 70%-95% has a high carbon solubility, so that the formation of chromium carbides and the associated relatively high susceptibility to intergranular corrosion are efficiently counteracted. A delta ferrite content of between 10% and 15% may preferably be provided, corresponding to an austenite content of between 90% and 85%.
d) During case hardening in the aforementioned temperature range with nitrogen diffusion, a mainly austenitic structure may be established in the surface zone of the first blank, which has a high solubility of carbon and nitrogen, so that the formation of chromium carbides or chromium nitrides and the associated binding of chromium and/or relatively high susceptibility to intergranular corrosion is efficiently counteracted.
e) After the heat treatment, there may be a mainly martensitic structure in the core area of the first blank, with a small proportion of delta ferrite of 5%-30% (preferably 10%-15%). The delta ferrite content can be deliberately limited to a maximum of 30%, since with higher delta ferrite contents the toughness could decrease again.
f) After the heat treatment, there may be a mainly martensitic structure in the surface zone of the first blank, so that a high degree of hardening can be achieved.
g) The first blank can be comparatively easily joined together with the second blank.
h) As a result of its advantageous corrosion behavior, the tip element made from the first blank can permanently contribute to load transfer, so that a particularly large effective screw length can be obtained.

Accordingly, in the method according to the invention, the step of case hardening the first blank with nitrogen from the gas phase is advantageously provided, preferably at temperatures between 1000° C. and 1150° C., particularly preferably between 1030° C. and 1100° C., and/or a nitrogen partial pressure between 0.05 bar and 0.3 bar, particularly preferably between 0.10 bar and 0.20 bar, preferably following a step of thread forming on the first blank. By such case hardening with nitrogen (alone or, as explained below, optionally in combination with carbon), the surface zone of the first blank can be specifically modified in a manner which is particularly advantageous, in particular for use with screw tips. In particular, during case hardening between 1000 and 1150° C., nitrogen can be dissolved in the surface zone of the then austenitic structure. In connection with the steel according to the invention, it has been possible by such case hardening to achieve a surface hardness of 580 HV0.3 or higher with a limit hardness of 550 HV0.3 at a distance from the surface of 0.15-0.30 mm (which may be particularly advantageous for concrete screws) or 0.1-0.15 mm (which may be particularly advantageous for self-tapping screws) and/or a core hardness of 350-400 HV0.3. This surface hardness in turn can ensure good resistance to thread wear, even when grooving in concrete and reinforcing bars, which in turn enables the screw to have a high load-bearing capacity. In addition, the dissolved nitrogen can locally increase the PRE index in the surface zone to 23 or higher and thereby significantly improve the resistance to pitting corrosion, preferably to a level comparable to a 1.4401 steel. In particular, the electrochemical measurand of the “breakthrough potential” can also be brought to a level comparable to that of a 1.4401 steel. The upper limit of the nitrogen partial pressure of 0.3 bar or 0.20 bar is due to the fact that the formation of chromium-containing and/or nitrogen-containing precipitates can thereby be counteracted efficiently, which is advantageous in terms of corrosion resistance. The lower limit of the nitrogen partial pressure of 0.05 bar or 0.10 bar is due to the fact that only from this pressure does the nitrogen have a significant effect. The atmosphere provided in the case-hardening step may be pure nitrogen or a gas mixture which has an equivalent nitrogen activity at the given temperatures. In particular, a pure nitrogen atmosphere may be provided if the process is carried out in a low-pressure furnace. In an atmospheric-pressure furnace, dilution could take place, for example with noble gases.

In particular, a complete martensitic transformation can be achieved in the first blank.

It may expediently be provided that the case hardening of the first blank with nitrogen from the gas phase takes place in combination with carburizing the first blank with carbon from the gas phase. In addition to an increase in the nitrogen content, an increase in the carbon content due to carbon diffusion from the gas phase may also be provided. This design is based on the realization that, with carbon and nitrogen available at the same time, the solubility of both elements simultaneously can be increased, a higher nitrogen content accompanied at the same time by avoidance of carbides and nitrides allowing a further advantageous increase in hardness and corrosion resistance to be achieved. In order to carry out the case hardening of the first blank with nitrogen from the gas phase in combination with the carburizing of the first blank with carbon from the gas phase, for example gaseous nitrogen-containing and carbon-containing media can be introduced into the process chamber separately from one another and alternately. Alternatively, a gas mixture which provides both carbon and nitrogen can be used (for example ethine, C₂H₂, together with N₂).

In particular, the method may comprise the step of “thread forming on the first blank”. In this step, a thread form can be attached to the first blank. In particular, the thread forming on the first blank may include non-cutting forming, in particular cold forming, preferably rolling, of the first blank. It is particularly preferred that the step of case hardening the first blank follows the step of thread forming on the first blank. Accordingly, the thread on the first blank is formed before hardening. Performing the case hardening at a time after the thread forming allows the thread forming to be simplified and particularly homogeneous product properties to be obtained.

The step of case hardening the first blank can expediently be followed by a step of freezing the first blank, preferably at temperatures below minus 80° C., particularly preferably at a temperature of minus 150° C., and then tempering the first blank, in particular at temperatures below 270° C., preferably at temperatures between 150° C. and 500° C., particularly preferably at temperatures between 200° C. and 250° C., and/or and holding times between 1 hour and 5 hours. As a result, an even higher hardness and/or toughness can be set without reducing the corrosion resistance.

In particular, a step of quenching the first blank may be provided between the step of case hardening the first blank and the step of freezing the first blank.

The first blank is expediently in wire form at the start of the method, that is to say it is a wire-shaped semi-finished product, which can further reduce the outlay.

Expediently, a second blank comprising a duplex steel or an austenitic stainless steel may be provided and the drive element made from the second blank. Such a steel may be particularly suitable for the drive element, in particular with regard to the production outlay, the corrosion properties and the load properties. For example, the steel which the second blank comprises may be an A2, A4, duplex, 1.4401, 1.4404, 1.4362, 1.4301 or 1.4578 steel.

The second blank is expediently in wire form at the start of the method, that is to say it is a wire-shaped semi-finished product, which can further reduce the outlay. In particular, the method may comprise the step “thread forming on the second blank”. In this step, a thread form may be attached to the second blank. The step of thread forming on the first blank and/or the step of thread forming on the second blank is expediently carried out before the joining together of the first blank and the second blank.

The first blank and the second blank are joined together, expediently by laser welding or resistance welding.

The invention also relates to a bimetallic screw which can be obtained and/or is obtained in particular in a method according to the invention. The bimetallic screw is formed with a tip element and a drive element, the tip element and the drive element having a different material composition. The bimetallic screw is distinguished by the fact that the tip element comprises at least in some areas a steel with 0.07 to 0.14% by weight carbon, 13 to 15% by weight chromium, 1.3 to 1.7% by weight molybdenum, 1.5 to 2.0% by weight nickel and 1.0 to 1.5% by weight manganese. In addition, this steel may comprises other elements customary for steel, for example vanadium (in particular <0.2% by weight), niobium (in particular <0.2% by weight), titanium (in particular <0.2% by weight) and/or silicon (in particular <0.5% by weight). The rest is iron with inevitable impurities, for example sulfur and/or phosphorus, in particular in each case <0.02% by weight. The figures given as “% by weight” can be understood as meaning percentages by weight in a customary sense. The steel preferably has a proportion by weight of 0.08 to 0.12% by weight carbon. The steel of the tip element may in particular be case-hardened and/or carburized with nitrogen from the gas phase. In particular, the steel of the tip element may be a martensitically hardened, stainless steel.

With such a screw, the advantages of steel described above can be implemented in one product.

The drive element may expediently comprise a duplex steel or an austenitic stainless steel, at least in some areas. Such a steel may be particularly suitable for the drive element, in particular with regard to the production outlay, the corrosion properties and the load properties. For example, said steel of the drive element may be an A2, A4, duplex, 1.4401, 1.4404, 1.4362, 1.4301 or 1.4578 steel.

Features that are explained in connection with the method for producing a bimetallic screw can also be used for the bimetallic screw, and conversely features that are explained in connection with the bimetallic screw can also be used in the method for producing a bimetallic screw. In particular, the bimetallic screw may be made in the method described, that is to say the bimetallic screw may be the product of the method described. In particular, the steels described in connection with the method and the screw may be the same.

The insertion end of the bimetallic screw is arranged on the tip element. The drive element has in particular a rotary drive for rotating the bimetallic screw, for example a screw head with an external polygonal structure or an internal polygonal structure. In particular, the drive element and the tip element may together form the shaft of the bimetallic screw. The drive element and the tip element preferably have a continuous thread.

The bimetallic screw may preferably be a self-tapping bimetallic screw. It may in particular be a concrete screw, that is to say a screw for cutting into concrete.

The ratio of the outside diameter of a thread of the bimetallic screw to the thread pitch of the thread may be in the range from 1 to 2, in particular in the range from 1.2 to 1.45. These are typical thread dimensions for screws intended for self-tapping screwing into mineral substrates such as for example concrete. The pitch may be understood in particular as meaning the axial distance between successive turns of a thread. According to the invention, a concrete substrate may also be provided with a hole into which a bimetallic screw according to the invention is screwed, a negative form with respect to the cutting thread of the bimetallic screw being formed in the concrete substrate. Accordingly, the bimetallic screw has been screwed into the hole in the concrete substrate in a self-tapping manner to form a counter-thread.

The invention is explained in more detail below on the basis of preferred exemplary embodiments, which are shown schematically in the accompanying FIGURE, while individual features of the exemplary embodiments that are described below can in principle be implemented individually or in any combination within the scope of the invention. The FIGURE shows schematically:

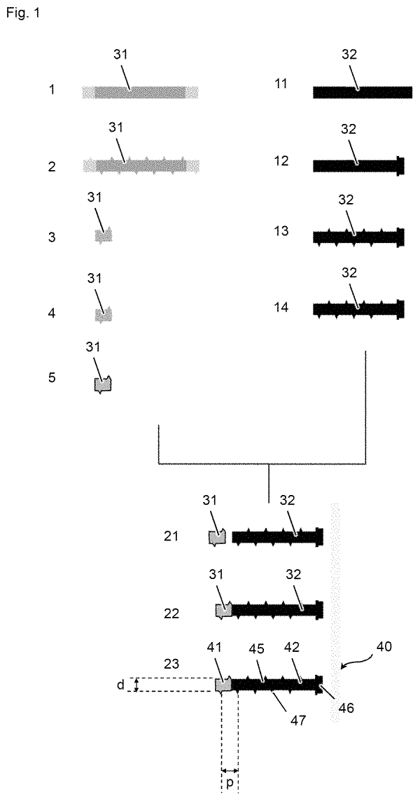

FIG. 1: a schematic flow diagram of a production method according to the invention.

FIG. 1 schematically shows a flow diagram of a possible embodiment of a method according to the invention for producing a bimetallic screw 40 with a tip element 41 and a drive element 42.

In order to obtain the tip element 41, in step 1 a first blank 31, preferably a wire-shaped first blank 31, made of a steel containing 0.07 to 0.14% by weight, preferably 0.08 to 0.12% by weight, carbon, 13 to 15% by weight chromium, 1.3 to 1.7% by weight molybdenum, 1.5 to 2.0% by weight nickel and 1.0 to 1.5% by weight manganese is provided. In addition, the steel may comprises other elements customary for steel, for example vanadium (in particular <0.2% by weight), niobium (in particular <0.2% by weight), titanium (in particular <0.2% by weight) and/or silicon (in particular <0.5% by weight). The rest is iron with inevitable impurities, for example sulfur and/or phosphorus, in particular in each case <0.02% by weight.

This is followed in step 2 by thread forming on the first blank 31, whereby an external thread section is formed on the first blank 31. The thread forming may in particular be thread rolling.

The first blank 31 is then cut to length in step 3 and cleaned in step 4.

In the subsequent step 5, the first blank 31, which is in the form of a screw, is hardened in a nitrogen-containing gas atmosphere at a temperature greater than 900° C., in particular between 1000° C. and 1150° C., particularly preferably between 1030° C. and 1100° C., the nitrogen partial pressure of the gas atmosphere preferably being between 0.05 bar and 0.6 bar, preferably less than 0.3 bar and particularly preferably less than 0.20 bar. The gas atmosphere may optionally also contain carbon. Following this, still in step 5, the first blank 31 is quenched, in particular gas-quenched, then frozen, in particular at temperatures below minus 80°, for example at minus 150° C., and finally tempered, preferably in a temperature range between 150° C. and 500° C., particularly preferably between 200° C. and 250° C., and/or a holding time between 1 hour and 5 hours.

In order to obtain the drive element 42, in step 11 a second blank 32, preferably a wire-shaped second blank 32, made of a duplex steel or an austenitic stainless steel is provided.

Then, in step 12, a head is then formed on the second blank 32, for example by upsetting. The head can form the rotary drive 46 on the finished bimetallic screw 40.

This is then followed in step 13 by thread forming on the second blank 32, as a result of which an external thread section is formed on the second blank 32. The thread forming may in particular be thread rolling.

The second blank 32 is then cleaned in step 14.

In step 21, the first blank 31 is arranged in front of the second blank 32 and brought into a position in which the first blank 31 contacts the second blank 32 and the external thread section on the first blank 31 forms an extension of the external thread section on the second blank 32.

Then, in step 22, the first blank 31 and the second blank 32 are joined together, for example by laser welding or resistance welding.

The composite comprising the first blank 31 and the second blank 32 can optionally be passivated in step 23.

Finally, the bimetallic screw 40 shown at 23 is obtained with a metallic tip element 41 and a metallic drive element 42 of a different material, the tip element 41 being obtained from the first blank 31 and the drive element 42 being obtained from the second blank 32. The bimetallic screw 40 has a cylindrical screw shaft 45, at the end of which a hexagon screw head is provided, forming a rotary drive 46. The screw shaft 45 is formed jointly by the drive element 42 and the tip element 41, and the rotary drive 46 is located at the rear end region of the drive element 42. Over the length of the screw shaft 45 there extends along the drive element 42 and the tip element 41 a thread 47 formed as a cutting thread, with an outside diameter d and a pitch p.

The screw shaft 45 of the bimetallic screw 40 can be screwed into a hole in a mineral substrate, in particular in a concrete substrate, the thread 47, which is formed as a cutting thread, being able to cut a corresponding thread in the substrate when screwed in.

1. A method for producing a bimetallic screw with a tip element and a drive element, the method comprising providing a first blank comprising a steel with 0.07 to 0.14% by weight carbon, 13 to 15% by weight chromium, 1.3 to 1.7% by weight molybdenum, 1.5 to 2.0% by weight nickel and 1.0 to 1.5% by weight manganese, and making the tip element from the first blank.

2. The method as claimed in claim 1, including:
case hardening the first blank with nitrogen from a gas phase.

3. The method as claimed in claim 2, including case hardening the first blank with nitrogen from the gas phase in combination with carburizing the first blank with carbon from the gas phase.

4. The method as claimed in claim 2, including thread forming on the first blank before case hardening the first blank.

5. The method as claimed in claim 1, including freezing the first blank at temperatures below minus 80° C. and then tempering the blank at temperatures between 150° C. and 500° C.

6. The method as claimed in claim 1, including providing a second blank comprising a duplex steel or an austenitic stainless steel, and making the drive element from the second blank.

7. The method as claimed in claim 6, including joining the first blank and the second blank together by laser welding or resistance welding.

8. A bimetallic screw with a tip element and a drive element, the tip element and the drive element having a different material composition, wherein the tip element comprises at least in some areas a steel with 0.07 to 0.14% by weight carbon, 13 to 15% by weight chromium, 1.3 to 1.7% by weight molybdenum, 1.5 to 2.0% by weight nickel and 1.0 to 1.5% by weight manganese.

9. The bimetallic screw as claimed in claim 8, wherein the drive element comprises at least in some areas a duplex steel or an austenitic stainless steel.

10. The bimetallic screw as claimed in claim 8, wherein the ratio of an outside diameter (d) of a thread of the bimetallic screw to a thread pitch (p) of the thread is in the range from 1 to 2.

11. The method of claim 2, including case hardening the first blank with nitrogen gas at temperatures between 1000° C. and 1150° C. and/or a nitrogen partial pressure between 0.05 bar and 0.3 bar phase.

12. The method as claimed in claim 3, including thread forming on the first blank before case hardening the first blank.

13. The method as claimed in claim 2, including freezing the first blank at temperatures below minus 80° C. and then tempering the blank at temperatures between 150° C. and 500° C.

14. The method as claimed in claim 3, including freezing the first blank at temperatures below minus 80° C. and then tempering the blank at temperatures between 150° C. and 500° C.

15. The method as claimed in claim 4, including freezing the first blank at temperatures below minus 80° C. and then tempering the blank at temperatures between 150° C. and 500° C.

16. The method as claimed in claim 12, including freezing the first blank at temperatures below minus 80° C. and then tempering the blank at temperatures between 150° C. and 500° C.

17. The method as claimed in claim 2, including providing a second blank comprising a duplex steel or an austenitic stainless steel, and making the drive element from the second blank.

18. The method as claimed in claim 3, including providing a second blank comprising a duplex steel or an austenitic stainless steel, and making the drive element from the second blank.

19. The bimetallic screw as claimed in claim 9, wherein the ratio of an outside diameter (d) of a thread of the bimetallic screw to a thread pitch (p) of the thread is in the range from 1 to 2.

20. The bimetallic screw of claim 10, wherein the ratio of (d) of a thread of the bimetallic screw to (p) of the thread is in the range of from 1.2 to 1.45.
